(19) United States
(12) Patent Application Publication
(10) Pub. No.: US 2010/0097956 A1
(43) Pub. Date: Apr. 22, 2010

(54) MULTI-INTERFACE MANAGEMENT CONFIGURATION METHOD AND GRAPHICAL USER INTERFACE FOR CONNECTION MANAGER

(75) Inventors: Miriam TAUIL, Berkeley Heights, NJ (US); Raquel Morera, Morristown, NJ (US); Kaustubh Sinkar, New Brunswick, NJ (US); Yoshihiro Oba, Englewood Cliffs, NJ (US)

Correspondence Address: ATTN: Stephen B. Parker (WPD);Westerman, Hattori, Daniels & Adrian, LLP, 1250 Connecticut Ave., Suite 700, Washington, DC, 20036, US

(73) Assignees: TOSHIBA AMERICA RESEARCH, INC., Piscataway, NJ (US); TELCORDIA TECHNOLOGIES, INC., Piscataway, NJ (US)

(21) Appl. No.: 12/423,781

(22) Filed: Apr. 14, 2009

Related U.S. Application Data
(60) Provisional application No. 61/106,812, filed on Oct. 20, 2008.

(51) Int. Cl. H04L 12/28

(52) U.S. Cl. 370/254

(57) ABSTRACT

A terminal device includes interfaces that establish links to networks. The networks can be wired, wireless, and the like. The terminal device includes a connection manager that manages the network connections based on configured parameters. Based on the configuration parameters it may compare network performance of different links in the device and it may switch or connect to a link having the best connectivity. Parameters are set to configure the connection manager and how it operates. The parameters can be set via a graphical user interface by the user or alternatively by the operator administrator.

The present application is a non-provisional of U.S. provisional application Ser. No. 61/106,812, entitled Multi-Interface Management Software Graphical User Interface, and filed on Oct. 20, 2008, the entire disclosure of which is incorporated herein by reference.

### FIELD OF THE INVENTION

The present invention relates to managing connections to networks from a terminal, or mobile device. Particularly, the present invention pertains to managing the device handover behavior and interaction or non-interaction with the user, based on setting configuration parameters for the specific interfaces and for the device.

### DISCUSSION OF THE RELATED ART

Portable devices, such as laptops, phones, personal digital assistants, and the like, include more than one network interface with a variety of wireless technologies. Depending on the access technologies type, communication capabilities, bandwidth, data rates, and power requirements will vary. Also real time conditions of the available networks affect the quality of service that can be provided on these networks. Thus, a portable, or mobile, device needs to select the best network access technology from the variety available based on certain criteria.

A portable or mobile device, hereinafter referred to as a “terminal,” usually is embedded with the multiple interfaces that allow access to different wireless networks. A number of network selection schemes may be used to select a wireless network to access from the terminal device. A terminal device may use policies and algorithms to select a recommended network. Terminal devices use automated switching and automatic interface enabling and disabling based on the policies and algorithms. Once the policies and algorithms determine a switch should occur, the switch happens without any user involvement. Although convenient, automated switching may not be desired for the following reasons.

The user preference to switch or not to switch to a recommended link can be based on factors other than performance such as: security, connectivity fee for the connection, specific applications/services available on that network and the like. While some of the policies related to user preferences can be applied to the algorithms used to calculate the recommended link, the user might prefer in some instances to consciously approve switching to a specific interface, by being asked by the connection manager if he wants to switch to a recommended link. A user might prefer this interaction instead of automated switching in the case that a special fee might be involved with the recommended link, for example.

Further, known devices display a list of preferred networks to a user. These networks are usually ranked according to some criteria, such as signal strength. The existing devices, however, do not provide any comparison of the available networks or the links to access those networks.

### SUMMARY OF THE INVENTION

The disclosed embodiments of the present invention incorporate the option to set parameters to configure the procedures a connection manager will use to switch networks or provide the user with the information to take action and switch to a recommended link.

Thus, the disclosed embodiments recite a method for configuring parameters for a connection manager of a terminal device. The method includes configuring a global parameter or an interface specific parameter by the user or alternatively configuring these parameters remotely by the operator administrator. The method also includes comparing network performance of a plurality of link associated with the interfaces on the terminal device. The serving interface is a connected interface that is used for data transmission. A serving interface is indicated by the graphical user interface.

According to the disclosed embodiments, a terminal device is recited. The terminal device may include a plurality of interfaces to connect with at least one network. A serving interface is within the plurality of interfaces.

The terminal device also includes a connection manager. The connection manager has the capability to determine network performance for the links associated with the interfaces on the device and the available networks. The connection manager behaves according to the global parameters, the interface specific parameters and network selection algorithms to manage the network connections.

The terminal device also includes a display on the terminal device to display a graphical user interface to set the global parameters or the interface specific parameters, and to indicate a serving interface, recommended link and connected links.

Further according to the disclosed embodiments, a method for configuring a terminal device to manage communications is recited. The method includes displaying a graphical user interface within a display on the terminal device. The method also includes setting an auto-selection parameter via the graphical user interface. The method also includes setting an auto-switching parameter via the graphical user interface. The method also includes setting an auto-link enabling parameter via the graphical user interface. The method also includes setting an auto-link disabling parameter via the graphical user interface. The method also includes setting all the parameters above remotely by the network operator administrator.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed in the claims.

FIG. 1 illustrates a terminal device having multiple interfaces to multiple networks according to the disclosed embodiments.

FIG. 2 illustrates a flowchart for setting and configuring parameters for a connection manager according to the disclosed embodiments.

FIG. 3 illustrates a flowchart for configuring parameters for the connection manager according to the disclosed embodiments.

FIG. 4 illustrates a table for the global parameters for device interaction with a connection manager according to the disclosed embodiments.

FIG. 5 illustrates a table for interface specific parameters for an interface according to the disclosed embodiments.

FIG. 6 illustrates a visual indication of a graphical user interface according to the disclosed embodiments.

FIG. 7 depicts a drop down menu to display interface characteristics, networks available and display performance information in a graphical user interface according to the disclosed embodiments.

FIG. 8 depicts a block diagram for menu options for interfaces listed in the graphical user interface according to the disclosed embodiments.

### DETAILED DESCRIPTION OF THE PREFERRED EMBODIMENTS

Reference will now be made in detail to the preferred embodiments of the present invention. Examples of the preferred embodiments are illustrated in the accompanying drawings.

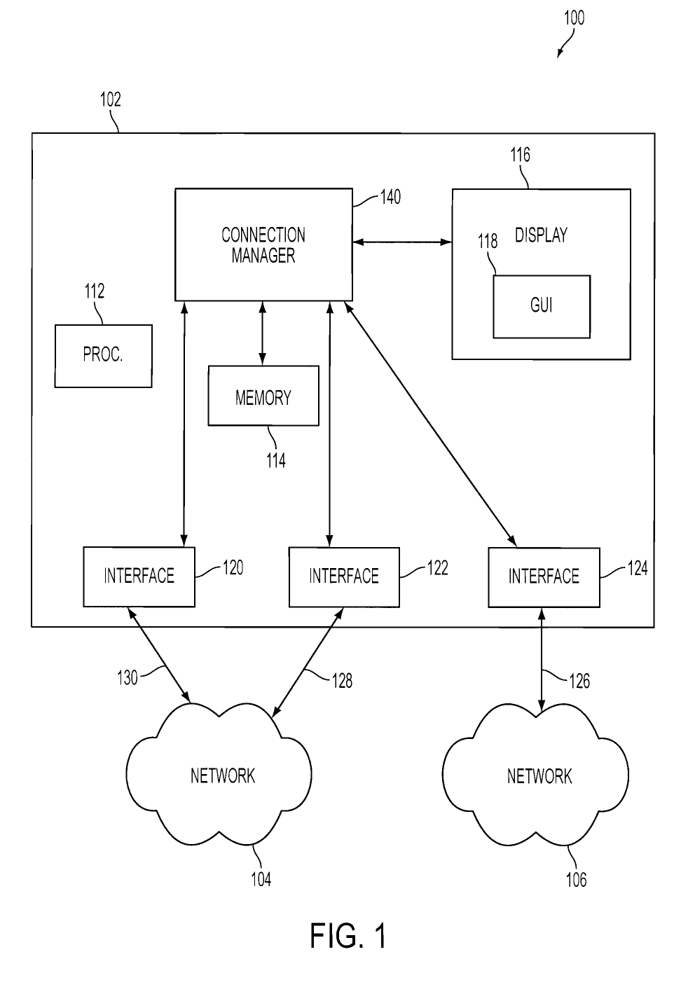

FIG. 1 depicts a terminal device 102 for use with networks according to the disclosed embodiments. Terminal device 102 may be a mobile or portable device having wireless and wired communications capability within environment 100. As shown in FIG. 1, terminal device 102 may connect to networks 104 and 106. Other networks may exist in environment 100 and also connect with terminal device 102.

Terminal device 102 includes various components and functions. For example, terminal device 102 includes a processor 112 and a memory 114. Processor 112 may execute commands stored or written into various functions, programs and algorithms stored on terminal device 102. Memory 114 may store these along with values, parameters, default settings and the like, needed by processor 112.

Terminal device 102 also includes a display 116 to display information to a user. Display 116 may be any display known in the art and also includes those displays where the information is shown apart from terminal device 102, such as a computer terminal or projection. Graphical user interface (GUI) 118 may be displayed on display 116 to interact with the user and receive input.

Terminal device 102 also includes network interfaces 120, 122 and 124. A network interface acts as an entry point to a network of particular link layer type. The link layer technology of a network interface may support multiple link layer or physical layer protocols or mechanisms. Terminal device 102 includes multiple interfaces. Preferably, network interfaces 120, 122 and 124 serve as entry points for a higher layer, such as an Internet protocol (IP) layer or above.

Connection manager 140 manages interfaces and the links to various networks. Connection manager 140 may include parameters that determine how to act when terminal device 102 switches networks or interfaces. Connection manager 140 also interacts with GUI 118 to display network information and performance.

The network interfaces may be connected to wired or wireless networks. For example, network interface 124 may be a wired network interface that uses wired media to receive and send information and data. Network interface 124 may be coupled to wired network 106 by link 105. Alternatively, terminal device 102 may connect to wireless networks, such as network 104.

Network 104 may use a wireless media to exchange information and data with terminal device 102 via wireless network interfaces 120 and 122. Network interfaces 120 and 122 may connect to wireless network 104 via links 130 and 128, respectively. Thus, wired network interface 124 and wireless network interfaces 120 and 122 may differ in their procedures, protocols and the like.

A network interface state may be associated with each network interface. A network interface state includes a value to indicate what “state” the associated interface is in. For example, the values for the network interface states may include disabled, network cable unplugged (for wired network interfaces), disconnected, limited connectivity, local connectivity, Internet connectivity, and the like. These values, and others, may be indicated as attributes shown on GUI 118 and noted by connection manager 140.

A link layer connection exists between terminal device 102 and a network point of attachment. A link may be associated with only one network interface, such as link 130 with network interface 120. Alternatively, a link may be associated with multiple interfaces. One or more links may be present on a network interface when the network interface's state is something other than “disabled” or “network cable unplugged.” Connection manager 140 also may note these statuses.

A link may have a state associated with it. For example, link 130 from network interface 120 may have a link state associated with it. A link state may include one of the following values for that link: disconnected, limited connectivity, local connectivity, Internet connectivity and the like. These values, and others, may be indicated as link state attributes, disclosed in greater detail below.

A serving link may indicate a link for which application packets are transmitted and received. Multiple serving links may exist on terminal device 102. According to FIG. 1, link 130 may indicate the serving link for terminal device 102. Other links include candidate links 126 and 128. A candidate link refers to a link that is eligible for being a target link. A target link is a link that has been selected to be a serving link. For example, a candidate link also may become a target link if it is selected by a target link selection algorithm used by a target link selection function.

Further, interface 120 may be known as a serving interface. A serving interface is an interface that has at least one serving link. Serving interfaces, however, are transferring data for an application on terminal device 102. Application traffic from terminal device only uses a serving interface.

In other words, interfaces 120, 122 and 124 may be connected to a network, and, thus, shown in GUI 118 as “connected” interfaces. Serving interface 120, however, may be the only interface transferring data for an application being executed by processor 112. In switching networks or selecting a new link, the status and network performance of the serving interfaces are more important in some cases than that of other interfaces.

Using the example above, connected interfaces 122 and 124 may show great network performance, but are idle for an application running on terminal device. If there is an application that is actively generating traffic over the serving interface and no IP layer or application layer mobility management protocol is used for the application, a switch to a link supported by either interface should not occur as it can result in service interruption of the application.

The claimed embodiments may run a test on a serving interface automatically to determine network performance, as opposed to the user manually instructing terminal device 102 to do so. Thus, the information shown in GUI 118 is dynamic and updated as variations in performance occur. One or more examples of GUI 118 are disclosed in greater detail below.

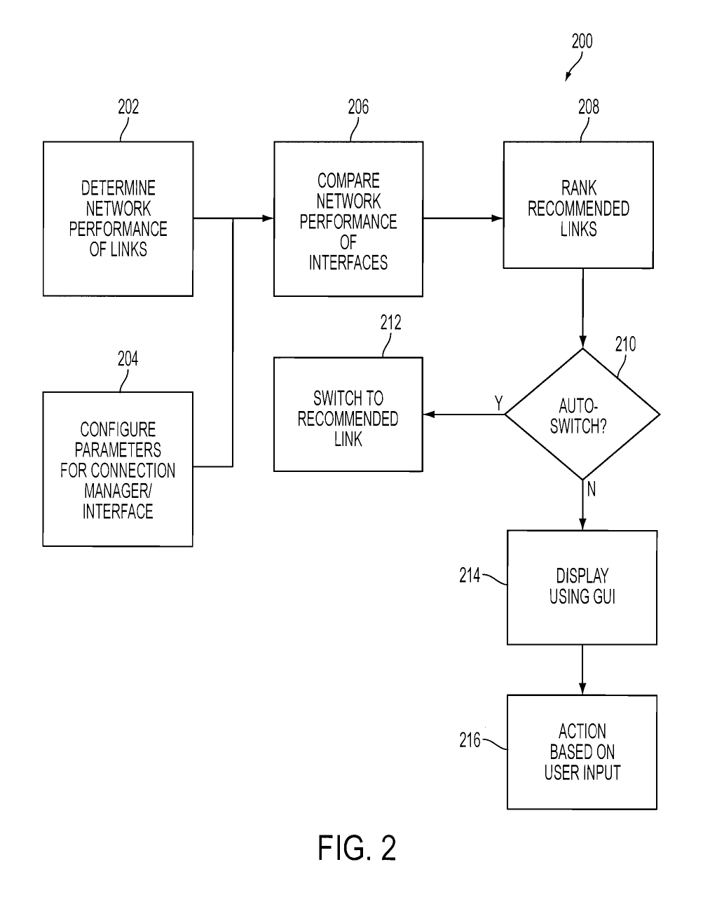

FIG. 2 depicts a flowchart 200 for setting and configuring parameters for connection manager 140 according to the disclosed embodiments. These actions may be performed using GUI 118, which provides drop down menus to select the various parameters. Connection manager 140 may store the parameters and use them in selecting and switching links via the interfaces to networks. Connection manager 140 may do so automatically without the need for user input once the parameters are configured.

Step 202 executes by determining the network performance on the links supported by the interfaces on terminal device 102. Of particular interest during this step is Internet connectivity on a serving interface. A good signal strength having poor Internet connectivity is not desirable in this instance. Connection manager 140 may run tests or other information gathering activities during this step.

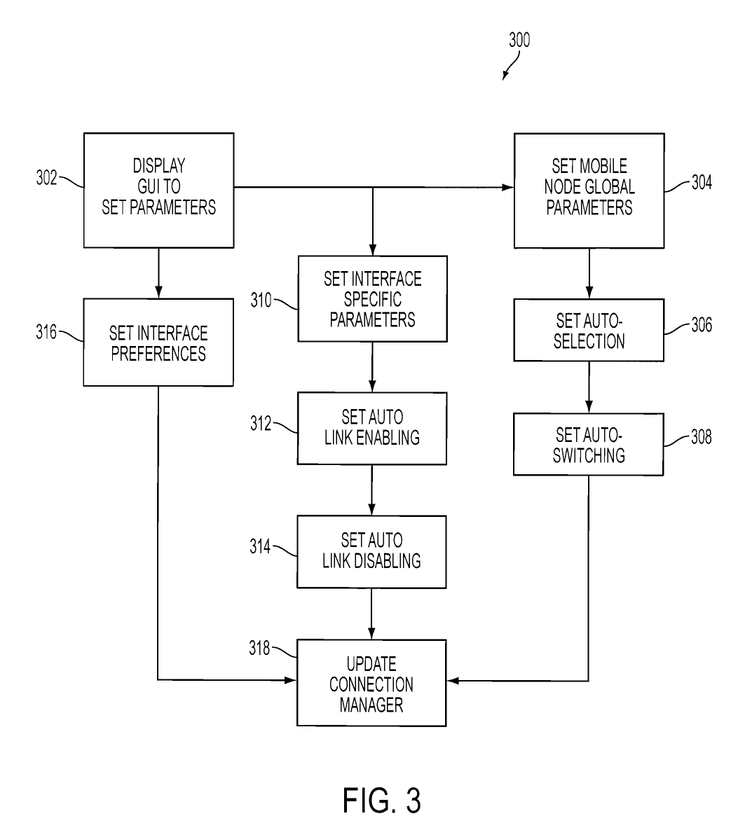

Step 204 executes by configuring the parameters for connection manager 140 and any associated interfaces. The parameters may determine the behavior of connection manager 140 during the selection and switching processes. Step 204 is disclosed in greater detail with regard to FIG. 3 below.

Step 206 executes by comparing the network performance determinations of the interfaces, with particular interest on any serving interfaces. Step 206 may use the parameters set in step 204 in doing the comparison, especially if a link or interface is favored over the others. Step 208 executes by ranking the recommended links according to the comparison results. These results may be displayed in GUI 18.

Step 210 executes by determining whether the auto-switch parameter has been enabled so as to switch to a favored link based on the rankings. In other words, if a link showing better network performance, such as Internet connectivity, is available according to the rankings, then connection manager 140 may automatically switch to that link and its associated interface without user input. Thus, connection manager 140 may dynamically switch networks based on the performance.

Is step 210 is yes, then step 212 executes by switching to the recommended, or favored, link as instructed by connection manager 140. If step 210 is no, then step 214 executes by displaying the comparison results on display 116. As disclosed below, certain information may be available to the user in GUI 118, which shows serving interfaces and their performance results. Step 216 executes by performing an action based on user input, if any, provided via GUI 118. Alternatively, connection manager 140 may perform a pre-set action based on the configured parameters.

FIG. 3 depicts a flowchart 300 for configuring parameters for connection manager 140 according to the disclosed embodiments. Flowchart 300 may relate to step 204 of FIG. 2. Step 204, however, is not limited by the embodiments disclosed by FIG. 300.

Step 302 executes by displaying GUI 118 to a user to set the parameters to configure the behavior of connection manager 140. GUI 118 may have a variety of configurations and displays, and these will be disclosed in greater detail below.

Step 304 executes by setting mobile node global parameters. Mobile node global parameters are those parameters applicable for all interfaces within terminal device 102. Global parameters can be configured by the user or by an operator administrator acting on behalf of the user to provide the user with the user's requested service. The two parameters disclosed below pertain to auto-selection and auto-switching, but additional global parameters also may be included.

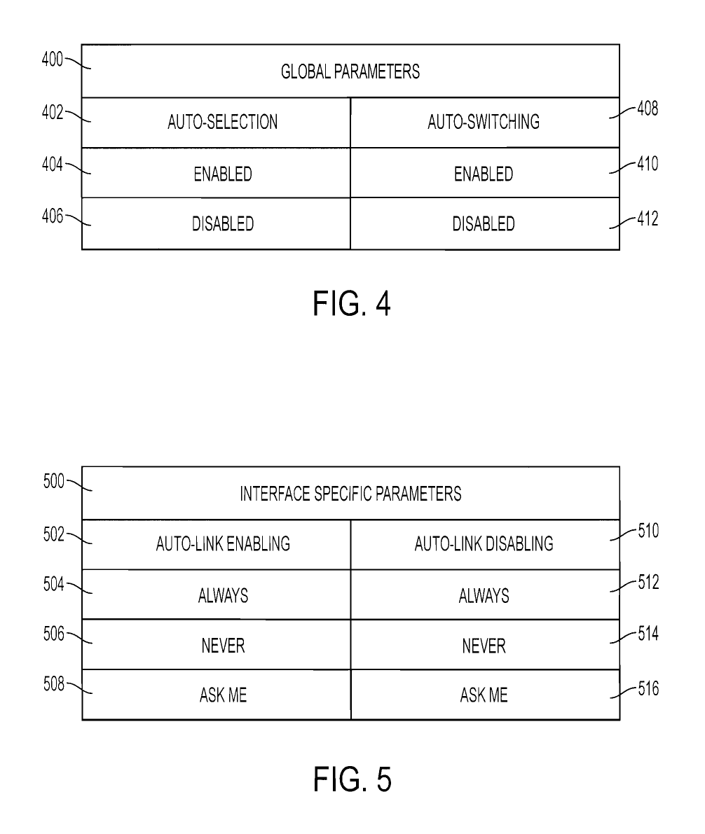

Step 306 executes by setting the auto-selection parameter for all interfaces on terminal device 102. The auto-selection parameter may have two options: enabled and disabled. Referring to FIG. 4, a table 400 is shown for the global parameters of the interfaces interacting with connection manager 140 according to the disclosed embodiments. Table 400 may be stored in memory 114 of terminal device 102 and set via GUI 118.

Auto-selection parameter 404 includes enabled parameter 406 and disabled parameter 408. If enabled parameter 406 is indicated via step 306, then connection manager 140 will perform tests of network performance and display recommended links via GUI 118. The tests may be performed periodically or in a dynamic fashion. Further, the tests may be performed when signal strength or another network performance factors are above or below a specified level.

If disabled parameter 406 is indicated via step 306, then connection manager 140 will not perform any tests for network performance. Further, connection manager 140 will not use GUI 118 to display any results from testing because no tests were performed. Thus, no dynamic selection processes should occur while this parameter is set.

Step 308 executes by setting auto-switching parameter 408 for all interfaces on terminal device 102. Auto-switching enables the feature of switching to a recommended link that is better than the current link serving link. The switch will be automatic. Auto-switching parameter 408 may have two options: enabled and disabled. Referring to FIG. 4, auto-switching parameter 408 includes enabled parameter 410 and disabled parameter 412.

Much like auto-selection, the user configures how connection manager 140 behaves by entering the appropriate information for parameters 410 and 412. If enabled parameter 410 is indicated in step 308, then auto-switching is “on.” Connection manager 140 will actively select the best link if it is different than the current serving link. Connection manager 140 may automatically switch and also may notify the user about the switching. The notification may occur by using a pop-up window in display 116 when the auto-switching happens.

If disabled parameter 412 is indicated in step 308, then the auto-switching feature is disabled. Connection manager 140 does not select any link different from the current serving link, unless instructed to by the user. This action may occur if auto-selection is enabled in step 306 and a pop-up window alerts the user that they may switch to the best link. Switching may still occur despite disabled parameter 412 being indicated.

Step 310 executes by setting the interface specific parameters using GUI 118 to configure connection manager 140. Interface specific parameters impact the selected interface, such as interfaces 120, 122 and 124 of FIG. 1. These parameters are not “global.” Interface specific parameters can be configured by the user or by an operator administrator acting on behalf of the user to provide the user with the user's requested service.

Referring to FIG. 5, a table 500 is shown for interface specific parameters for an interface according to the disclosed embodiments. For example, table 500 may refer to the interface specific parameters for interface 120. Table 500 may be stored in memory 114 of terminal device 102 and accessible by connection manager 140.

Step 312 executes by setting auto-enable parameter 502. Auto-enabling is significant when auto-selection is enabled as a global parameter, as disclosed above. The user may configure this parameter via GUI 118 in connection manager 140 for a specific interface. Referring to table 500, three possible values may be set: always, never and ask me. Thus, auto-enable parameter 502 includes always parameter 504, never parameter 506 and ask me parameter 508.

If always parameter 504 is indicated as the value for auto-enabling, then connection manager 140 will always switch when this interface is the best link. If never parameter 506 is indicated, then connection manager 140 will not switch. If ask me parameter 508 is indicated, then connection manager will query the user whether to switch. Based on the response, connection manager 140 will act.

An “ask me” indication for auto-enabling also may include various options for connection manager 140 to follow. One option may be that every time connection manager 140 evaluates links for best link recommendation, and a disabled link has an associated “auto-enabled” parameter with the value “ask me” for parameter 508, then the user is asked if the relevant link can be enabled for the purpose of evaluation and recommendation.

Because the above option may require frequent user interaction, other options may be employed to limit these interactions. For example, connection manager may allow the user to configure a time interval when auto-enabled parameter 502 has a value of “ask me” as indicated by ask me parameter 508. After the time interval expires, the next instance that connection manager 140 performs a best link evaluation, the user may be queried if connection manager 140 can enable the related interface. A timer with the time interval may be set periodically for requesting the user permission to enable the interface. If the time interval has not expired, then the user is not queried.

Another option includes asking the user to enable the disabled link only the first time that connection manager 140 evaluates the corresponding link. Connection manager 140 may use the response, but the response does not override the ask me configuration set for auto-enabled parameter 502. The query may occur, for example, each time terminal device 102 is started up.

Yet another option for acting when ask me parameter 508 is set is asking the user to enable the relevant interface when the serving interface as well as the enabled interfaces have bad connectivity. This option may be viewed as a “last resort” situation in that no other interface provides the desired connectivity.

Step 314 executes by setting auto-disable parameter 510 for a specific interface. Auto-disabling is relevant when auto-switching is enabled. Auto-disabling instructs the specified interface to automatically disable or not disable upon switching to another interface.

If always parameter 512 is indicated, then the interface will always disable if another interface is deemed to be the serving interface due to auto-switching. Connection manager 140 should note this, even if it is not actively involved with this action. By disabling the interface upon switchover, power may be saved within terminal device 102.

If never parameter 514 is indicated, then the interface will not disable upon switchover. The interface stays enabled in case connection manager 140 switches back due to problems with the new serving interface. Connectivity may be temporary for the new link and the old link needs to be enabled when that connection terminates. Connection manager 140 notes this and continues to evaluate the link on the former serving interface.

If ask me parameter 516 is indicated, then the user is queried as to whether the former serving interface should be disabled. Some of the options associated with ask me parameter 508 may be used for auto-disabling as well to reduce interactions with the user.

Step 316 executes by setting user preferences within connection manager 140. In this step, the user can configure link preferences so that recommended links are taken into account during the evaluation process. A link may be “preferred” over others, and, thus, overriding the network performance evaluations. Further, the user may select different modes that determine how connection manager 140 will act.

For example, the main configuration window shown by GUI 118 allows the user to have connection manager 140 order the interfaces in terminal device 102 by preference. The higher the interface is listed, then the higher the preference. A default suggested order would be based on the interface type. An order may be established, such as LAN, Wifi, 30 and WiMax from highest to lowest preference.

The user can change the interface preferences by clicking on an interface on the list. The interface will be highlighted, or indicated in like fashion. The user may click an up or down arrow to change the ranking for interface preference.

Step 318 executes by updating connection manager 140 with the parameters and preferences set in steps 304-316. The parameters service to configure connection manager 140, and stay in place until step 302 is executed again to set the parameters.

Examples of GUI 118 for setting the parameters for connection manager 140 are disclosed in greater detail below. These examples may provide a visual representation of how the information is displayed to the user. Other interfaces and visual representations may be used, as known in the art.

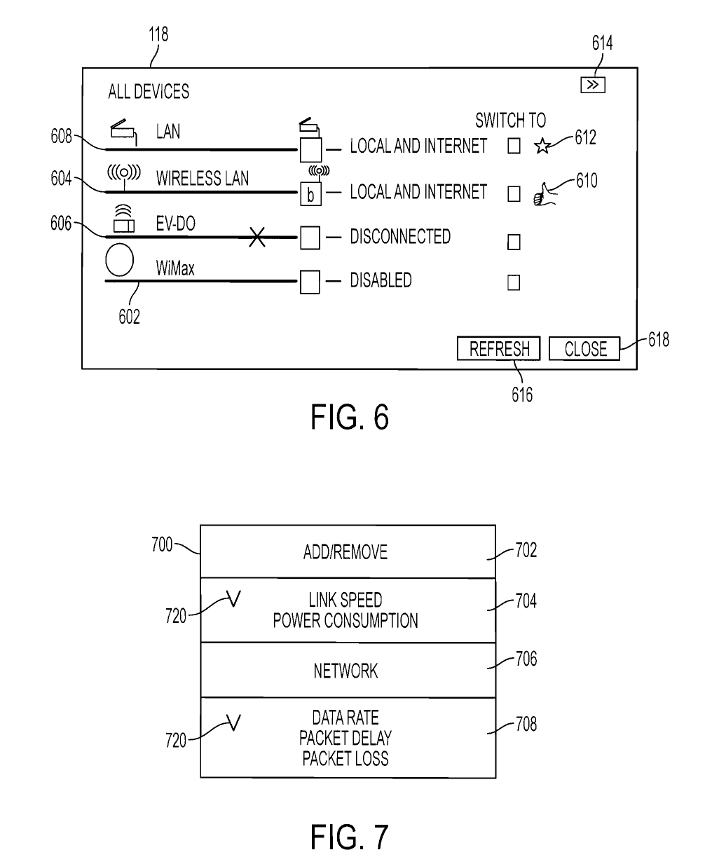

All of interfaces in terminal device 102 may be listed with certain visual indications, such as the following visual indications as depicted in FIG. 6. GUI 118 is shown with the visual indications for applicable interfaces and links. A disabled interface is shown by line 602. Preferably, line 602 is grey.

An enabled interface that is connected, but not used for transmission is shown by line 604. Preferably, line 604 is black. Line 606 represents an enabled interface that is disconnected. More preferably, line 604 is solid black with a red “x” marked on the line.

Line 608 represents an enabled interface that is connected and being used for data transmission, or the serving interface. Preferably, line 608 is a solid black line with animation to show that link is being used to transmit packets. Because this interface is the serving interface, a star icon 612 is used to show this status on GUI 118. A recommended interface, if any, may be marked with thumbs up icon 610.

The user may take the following actions via GUI 118 shown in FIG. 6. The user may add additional information on this screen by clicking on the illustrated arrows 614, and selecting specific information to be displayed from a drop down menu, disclosed in greater detail with regard to FIG. 7 below. Preferably, the user can customize what information is displayed in the window, or GUI 18.

The user also may use Refresh button 616 to refresh the current information displayed in GUI 118. The user further may use Close button 618 to close the window for GUI 118.

FIG. 7 depicts a drop down menu 700 to configure the information displayed in GUI 118 according to the disclosed embodiments. Using drop down menu 700, the user can add more information for display regarding all the available interfaces in terminal device 102. For some interfaces, some of the information might not be available. For example, network performance information may be available only for connected interfaces. In some embodiments, the user configured displayed information will persist until the user changes that information again.

Drop down menu 700 includes fields that list the various types of information available for display. Field 702 includes a designation for add/remove depending on the status of the information. A visual indication on the left side of a listing may indicate whether the information is currently being displayed, as shown by indications 720. No indication means the listed information is not being displayed in GUI 118. By clicking on a particular field in drop down menu 700, the user may select/deselect such field or listing for display depending on its current status.

As shown in FIG. 7, the following fields are in drop down menu 700 to configure display in the window for GUI 18. Field 704 includes link speed, or the expected throughput, and power consumption. Field 706 includes network, such as SSID, operator and the like. Field 708 includes data rate, or throughput, packet delay and packet loss. Additional fields may be included in drop down menu 700.

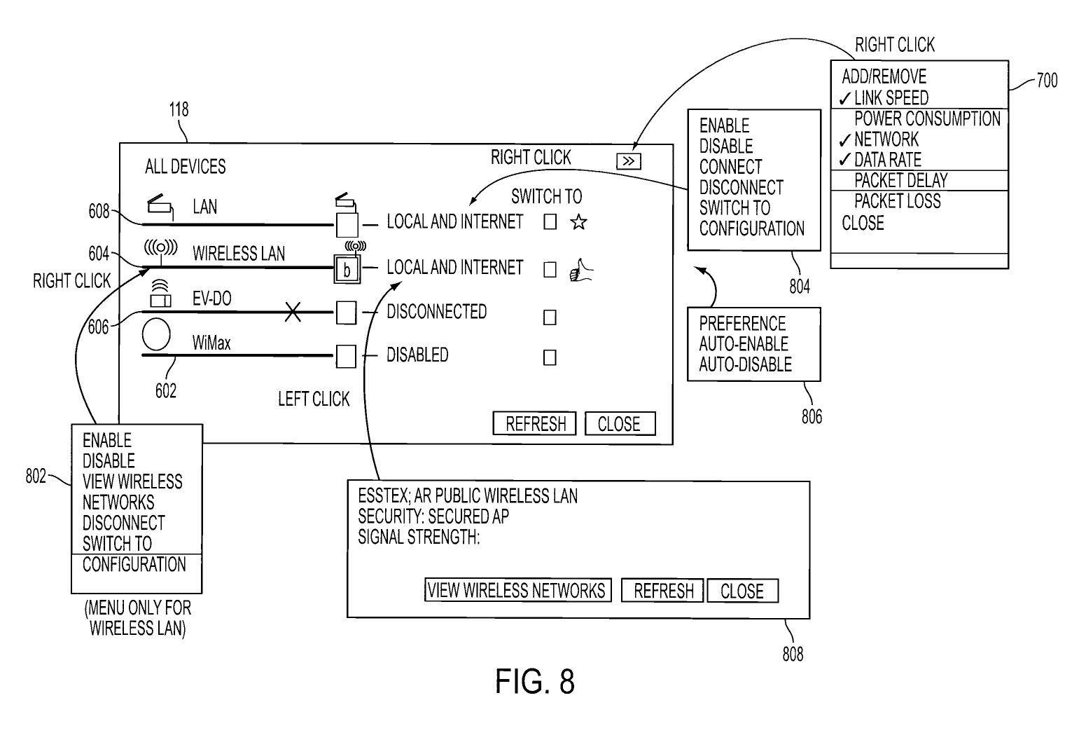

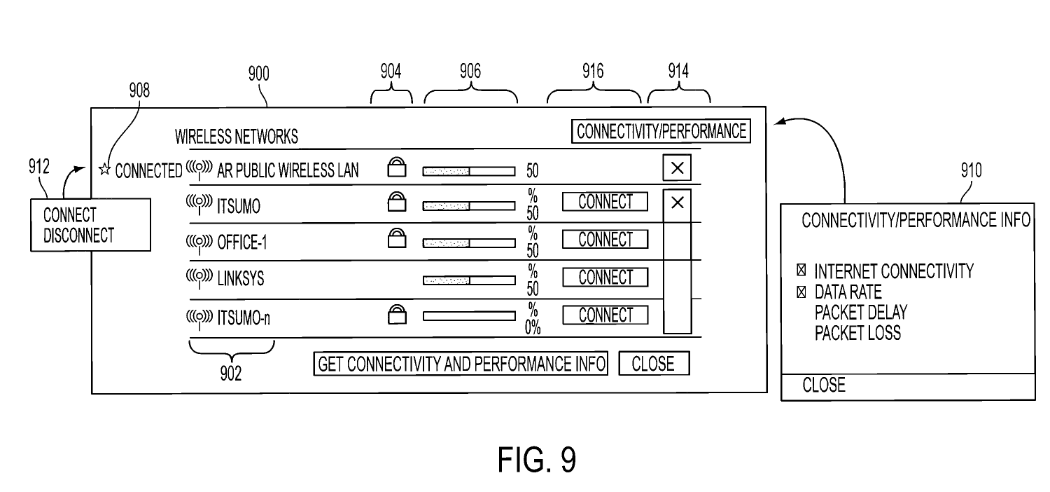

FIG. 8 depicts a block diagram for menu options for interfaces listed in GUI 118 according to the disclosed embodiments. GUI 118 is similar to the one shown in FIG. 6 and includes the same features. The menus shown in FIG. 8 are available when the user performs a “right click,” or similar action, on a specific line representing an interface. The action provides the user with the relevant options for that interface. The actions available to the user depend on the state and type of each interface.

For example, menu 802 provides the options for the wireless interface shown by line 604. Menu 802 provides options for wireless local area networks. Menu 804 provides the options for the wired interface shown by line 608. Menu 806 provides the options to auto-enable or auto-disable an interface, as disclosed above. Menu 808 provides information regarding a wireless network and further buttons to click on to view wireless network.

Referring to menus 802 and 804, the “connect” and “switch to” options are two different actions. One difference between these actions is that when switching to a new link, the user may be asked if to disable old connected links. A connect operation will have no impact on other interfaces except the connected one, and may not require a disable action. When two or more interfaces are used at a time, the impact of “switch to” can be established by user input or other manners known in the art.

For both operations, if the selected interface is a WLAN interface and it currently is not connected, then the user may select “view wireless networks” first to select the network to connect to or switch to. Preferably, when “view wireless networks” is selected, a new window may be opened and displayed. This feature is disclosed in greater detail below.

FIG. 9 depicts a window 900 that displays “view wireless networks” information according to the disclosed embodiments. Window 900 may be displayed on display 116 when prompted by a user. Window 900 may be displayed on top of the network information window, such as shown by GUI 118.

Preferably, the following default information is displayed for the wireless, or WLAN, networks. The default information includes identifications 902 to designate the different wireless networks. Lock icons 904 indicates whether security is enabled or disabled. A “lock” may indicate that security is enabled. Visual bars 906 indicate the signal strengths of the wireless networks. Visual star icon 908 indicates which network terminal device 102 is connected to.

A user may take the following actions on window 900. When a connected interface, as indicated by visual star icon 908, is clicked, additional information is displayed. For example, menu 910 may be displayed when indicated. Menu 910 may list connectivity and network performance information that can be displayed. Initially, only internet connectivity is displayed. Menu 910 may be a drop down menu to allow the option to select what additional information will be displayed when chosen.

When visual star icon 908 is clicked, menu 912 is displayed to allow connecting or disconnecting of the corresponding interface. Further, the user might select one of check boxes 914 to perform network performance tests on the associated network. After the selection, indicating the “get connectivity and performance info” button will trigger getting and displaying the desired information. The action may include clicking one of the connect buttons 916 to connect the associated interface of terminal device 102 with the selected network.

It will be apparent to those skilled in the art that various modifications and variations can be made in the disclosed embodiments of the present invention without departing from the spirit or scope of the invention. Thus, it is intended that the present invention covers the modifications and variations of the embodiments disclosed above provided that they come within the scope of any claims and their equivalents.

What is claimed is:

1. A method for configuring parameters for a connection manager of a terminal device having a plurality of interfaces, the method comprising:
configuring at least one global parameter and at least one interface specific parameter, wherein the at least one global parameter and at least one interface specific parameter are used by the terminal device for selecting a plurality of links, and further wherein each link of the plurality of links is associated with an interface; and
performing or not performing a handover to one of the plurality of links based on the at least one global parameter and at least one interface specific parameter.
wherein the at least one global parameter relates to a parameter applicable for the plurality of interfaces within terminal device and the at least one interface specific parameter relates to a parameter applicable to an interface of the plurality of interfaces.

2. The method of claim 1, wherein the configuring step includes configuring an auto-selection parameter to indicate whether the terminal device does a performance testing of the plurality of links and recommending a best link based on the performance testing.

3. The method of claim 1, wherein the configuring step includes configuring an auto-switching parameter to indicate whether the terminal device switches automatically to a recommended link, or interacting with an user to ask the user if the user would like to switch to a recommended link.

4. The method of claim 1, wherein the configuring step includes configuring an auto-enable parameter for the interface in the device, to indicate whether the terminal device automatically enable the interface for the purposes of doing a performance testing of the plurality of links related to the interface.

5. The method of claim 1, wherein the configuring step includes configuring an auto-disable parameter for the interface in the terminal device to indicate whether the terminal device automatically disables the interface after switching from the other interface.

6. The method of claim 1, where a user can directly configure these configuration parameters or an operator administrator can configure these parameters remotely on behalf of the user, to provide the user with the user's requested service.

7. The method of claim 1, further comprising uniquely identifying and visually presenting to a user a recommended link from the plurality of links based on the comparing step.

8. The method of claim 1, further comprising uniquely indentifying and visually presenting to a user a serving interface in a graphical user interface.

9. The method of claim 1, further comprising uniquely indentifying and visually presenting to a user a connected interface in a graphical user interface to distinguish between a serving interface and the connected interface.

10. The method of claim 1, further comprising allowing a user or the operator administrator ranking each of the plurality of interfaces in terms of preference from highest to lowest, wherein a connection manager considers the preference to calculate a recommended link.

11. A terminal device comprising:
a plurality of interfaces to connect with at least one network, wherein a serving interface is within the plurality of interfaces;
a connection manager to determine network performance for each connection between the plurality of interfaces and the at least one network, wherein the connection manager behaves according to a global parameter or an interface specific parameter and connects to or switches from the serving interface based on the global parameter or the interface specific parameter; and
a display on the terminal device to display a graphical user interface to set the global parameter or the interface specific parameter, and to indicate a status of the serving interface.

12. The terminal device of claim 11, further comprising a memory accessible by the connection manager to store the global parameter or the interface specific parameter.

13. The terminal device of claim 11, wherein the plurality of interfaces includes a recommended link and the connection manager switches to the recommended link from the serving interface.

14. The terminal device of claim 11, wherein the display displays a window to view information on wireless networks accessible by the terminal device upon receiving an instruction via the graphical user interface.

15. The terminal device of claim 11, further comprising a disabled interface from the plurality of interfaces, wherein a status of the disabled interface is uniquely identified in the graphical user interface.

16. The terminal device of claim 11, further comprising a connected interface different from the serving interface, wherein a status of the connected interface is uniquely identified in the graphical user interface.

17. A method for configuring a terminal device to manage communications, the method comprising:
displaying a graphical user interface within a display on the terminal device;
setting an auto-selection parameter via the graphical user interface;
setting an auto-switching parameter via the graphical user interface;
setting an auto-link enabling parameter for a specific interface of the terminal device via the graphical user interface;
setting an auto-link disabling parameter for the specific interface of the terminal device via the graphical user interface;
updating a connection manager for a plurality of interfaces based on the parameters; and
operating the connection manager to manage the plurality of interfaces for at least one network according to the parameters.

18. The method of claim 17, further comprising disabling a serving interface when the connection manager selects another interface for communications based on the auto-link disabling parameter.

19. The method of claim 17, further comprising switching to a recommended interface based on the auto-switching parameter;

20. The method of claim 17, further comprising comparing network performance of the plurality of links and uniquely identifying a serving interface in the graphical user interface.
